(19) United States
(12) Patent Application Publication
(10) Pub. No.: US 2020/0238754 A1
(43) Pub. Date: Jul. 30, 2020

(54) HUB-LESS RIM FOR A WHEEL OF A VEHICLE

(71) Applicant: Andre Bradford, Rensselaer, NY (US)

(72) Inventor: Andre Bradford, Rensselaer, NY (US)

(21) Appl. No.: 16/773,060

(22) Filed: Jan. 27, 2020

Related U.S. Application Data
(60) Provisional application No. 62/797,719, filed on Jan. 28, 2019.

(51) Int. Cl. B60B 21/04; B60B 21/12; B60Q 1/32; B60Q 1/26

(52) U.S. Cl. CPC B60B 21/04; B60B 21/12; B62M 3/08; B60Q 1/2696; B60Q 1/326

(57) ABSTRACT

Disclosed herein is a hub-less rim for a wheel of a vehicle is disclosed. The hub-less rim comprising may include an annular rim body characterized by an inner rim circumference and an outer rim circumference forming a rim interior space. Further, the hub-less rim comprising may include an internal gear rim tooth ring disposed on the annular rim body. Further, the hub-less rim comprising may include a plurality of spokes disposed on the annular rim body, wherein each spoke of the plurality of spokes comprises a base spoke end and a tip spoke end. Further, the hub-less rim comprising may include a lighting device disposed on the annular rim body, wherein the lighting device is attached to the at least one side rim surface proximal to the inner rim circumference, wherein the lighting device is configured for emitting light of at least one color.

### RELATED APPLICATION(S)

Under provisions of 35 U.S.C. § 119e, the Applicant(s) claim the benefit of U.S. provisional application No. 62/797,719, titled “Lighted Hub-Less Rims With Spokes For Vehicles”, filed on Jan. 28, 2019 which is incorporated herein by reference.

### TECHNICAL FIELD

Generally, the present disclosure relates to vehicles. More specifically, the present invention is a hub-less rim for a wheel of a vehicle.

### BACKGROUND

Conventional rims of a vehicle (such as a bicycle, or a motorcycle) may include hub and spokes that allows the wheel to mechanically couple with the vehicle. Further, the conventional rims with hub may increase an overall weight associated with the bicycle and may further increase drag, resulting in a reduction in efficiency associated with the vehicle. Further, vehicles are involved in accidents at night due to lower visibility.

Therefore, there is a need for an improved vehicle rim that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a hub-less rim for a wheel of a vehicle in accordance with some embodiments. The hub-less rim comprising may include an annular rim body characterized by an inner rim circumference and an outer rim circumference forming a rim interior space, wherein the annular rim body comprises at least one side rim surface and a top rim surface, wherein each side rim surface in the at least one side rim surface is defined by the inner rim circumference and the outer rim circumference. Further, the hub-less rim comprising may include an internal gear rim tooth ring disposed on the annular rim body, wherein the internal gear rim tooth ring is associated with a rim tooth ring circumference, wherein the internal gear rim tooth ring comprises a number of cut teeth corresponding to the rim tooth ring circumference, wherein the number of cut teeth is disposed on a side rim surface of the at least one side rim surface proximal to the outer rim circumference. Further, the hub-less rim comprising may include a plurality of spokes disposed on the annular rim body, wherein each spoke of the plurality of spokes comprises a base spoke end and a tip spoke end, wherein the base spoke end is attached to the at least one side rim surface proximal to the inner rim circumference and the tip spoke end extends radially in the rim interior space. Further, the hub-less rim comprising may include a lighting device disposed on the annular rim body, wherein the lighting device is attached to the at least one side rim surface proximal to the inner rim circumference, wherein the lighting device is configured for emitting light of at least one color.

According to some embodiments, a vehicle with a hub-less rim for a wheel is disclosed. The vehicle may include a vehicle body configured for accommodating at least one wheel. Further, the hub-less rim of the at least one wheel may include an annular rim body characterized by an inner rim circumference and an outer rim circumference forming a rim interior space, wherein the annular rim body comprises at least one side rim surface and a top rim surface, wherein each side rim surface in the at least one side rim surface is defined by the inner rim circumference and the outer rim circumference. Further, the hub-less rim of the at least one wheel may include an internal gear rim tooth ring disposed on the annular rim body, wherein the internal gear rim tooth ring is associated with a rim tooth ring circumference, wherein the internal gear rim tooth ring comprises a number of cut teeth corresponding to the rim tooth ring circumference, wherein the number of cut teeth is disposed on a side rim surface of the at least one rim surface proximal to the outer rim circumference. Further, the hub-less rim of the at least one wheel may include a plurality of spokes disposed on the annular rim body, wherein each spoke of the plurality of spokes comprises a base spoke end and a tip spoke end, wherein the base spoke end is attached to the at least one side rim surface proximal to the inner rim circumference and the tip spoke end extends radially in the rim interior space. Further, the hub-less rim of the at least one wheel may include a lighting device disposed on the annular rim body, wherein the lighting device is attached to the at least one side rim surface proximal to the inner rim circumference, wherein the lighting device is configured for emitting light of at least one color. Further, the vehicle may include at least one internal gear disposed on the vehicle body, wherein the at least one internal gear mechanically coupled with the internal gear rim tooth ring, wherein the at least one internal gear is associated with an internal gear circumference, wherein the at least one internal gear comprises a number of gear teeth corresponding to the internal gear circumference, wherein the internal gear circumference is less than the rim tooth ring circumference and the number of gear teeth is less than the number of the cut teeth. Further, the vehicle may include a drive mechanism disposed on the vehicle body, wherein the drive mechanism is operationally coupled with the at least one internal gear, wherein the drive mechanism is configured for generating a torque, wherein the at least one internal gear receives the torque from the drive mechanism, wherein the at least one internal gear transfers the torque to the internal gear rim tooth ring.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front right-side perspective view of a hub-less rim for a wheel of a vehicle, in accordance with some embodiments.

FIG. 2 is a front left-side perspective view of the hub-less rim, in accordance with some embodiments.

FIG. 3 is a side view of the hub-less rim, in accordance with some embodiments.

FIG. 4 is a top view of the hub-less rim, in accordance with some embodiments.

FIG. 5 is a side view of the hub-less rim, in accordance with some embodiments.

FIG. 6 is a side view of the hub-less rim, in accordance with some embodiments.

FIG. 7 is a side view of a vehicle with the hub-less rim, in accordance with some embodiments.

FIG. 8 is a front right-side view of the vehicle, in accordance with some embodiments.

FIG. 9 is a front right-side perspective view of a hub-less rim for a wheel of a vehicle, in accordance with some embodiments.

FIG. 10 is a front left-side perspective view of the hub-less rim, in accordance with some embodiments.

FIG. 11 is a side view of the hub-less rim, in accordance with some embodiments.

FIG. 12 is a top view of the hub-less rim, in accordance with some embodiments.

FIG. 13 is a side view of a vehicle with the hub-less rim, in accordance with some embodiments.

FIG. 14 is a front right-side perspective view of the vehicle, in accordance with some embodiments.

FIG. 15 is a side view of a vehicle with a hub-less rim for a wheel, in accordance with some embodiments.

FIG. 16 is an illustration of an online platform consistent with various embodiments of the present disclosure.

FIG. 17 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of lighted hub-less rims for vehicles, embodiments of the present disclosure are not limited to use only in this context.

Overview:

According to some embodiments, lighted hub-less rims with spokes for a vehicle is disclosed. Further, the lighted hub-less rim, in an instance, maybe a wheel (for vehicles) that may not include conventional hub assembly in order to mechanically couple with the vehicle. Further, the lighted hub-less rim, in an instance, may be configured to be mechanically coupled with the vehicles such as (but not limited to) bicycles, Velomobiles, motorcycles, cars, etc. Further, the lighted hub-less rim, in an instance, may include multiple components such as (but not limited to) an internal gear rim tooth ring, spokes, an inner layer, an outer layer, etc.

According to some embodiments, a hub-less rim for bicycles, velomobiles, motorcycles, cars, etc. is disclosed. Further, the hub-less rims may be available in many different model tires. Further, the hub-less rims may be available in various colors (such as but not limited to, lime green, pink, and blue). Further, the hub-less rim may be a neon-lit hub-less rim with spokes that uses an integral ring gear located on the bike. There may be a front and a back internal ring gear. The wheel may have double sided spokes that may come in a multiple of designs, and the rim may be neon-lit.

Further, an outer layer of the lighted hub-less rim, in an instance, maybe any wheel layer that may provide traction on a ground surface over which the vehicle may be moving. Further, the outer layer of the lighted hub-less rim, in an instance, may be made up of materials such as (but not limited to) synthetic rubber, natural rubber, fabric, and wire, carbon black, etc.

Further, the internal gear tooth ring of the lighted hub-less rim, in an instance, may be a ring structure with a number of cut teeth placed in between the inner layer and the outer layer of the lighted hub-less rim. Further, each cut teeth of the internal gear tooth ring, in an instance, may be configured to mesh with another toothed part (such as a rear internal ring gear, and a front internal ring gear of a bicycle in order to transmit torque. Further, the front internal ring gear, in an instance, may be a gear that may be mechanically coupled with the internal gear rim tooth ring of a front wheel of the vehicle. Further, the front internal ring gear, in an instance, may have a relatively smaller circumference (and/or diameter) than that of the internal gear rim tooth ring. Further, due to smaller circumference, the front internal ring gear may include a number of teeth significantly less than that of the internal gear rim tooth ring. Further, the rear internal ring gear, in an instance, may be a gear that may be mechanically coupled with the internal gear rim tooth ring of a rear wheel of the vehicle. Further, the rear internal ring gear, in an instance, may have a relatively smaller circumference (and/or diameter) than that of the internal gear rim tooth ring. Further, due to smaller circumference, the rear internal ring gear may include a number of teeth significantly less than that of the internal gear rim tooth ring. Further, the rear internal ring gear may receive a torque (through a chain) from pedals of the bicycle. Further, in order to move the bicycle, the rear internal ring gear may transfer torque (from the pedal) to the rear wheel of the bicycle by meshing with the teeth associated with the internal gear rim tooth ring.

Further, the inner layer of the lighted hub-less rim, in an instance, may be another ring structure with a diameter less than that of the outer layer and/or the internal gear rim tooth ring. Further, in one embodiment, the inner layer of the lighted hub-less rim may be configured to be coated with one or more colors that may light up in order to get easily distinguished by other drivers on the road. Further, the one or more colors associated with the inner layer of the lighted hub-less rim may include colors such as (but not limited to) lime green, pink, red, and/or blue, etc. Further, in another embodiment, the inner layer of the lighted hub-less rim may include one or more lights (such as, but not limited to, LEDs) that may be configured to illuminate the inner layer with the one or more colors. Further, the one or more lights, in an instance, may be configured to receive electrical power from a power source that may be present within the vehicle. Further, the power source, in an instance, may include (but not limited to) a battery. Further, the inner layer of the lighted hub-less rim, in an instance, may include a number of spokes. Further, the spokes, in an instance, may be spaced equally over the circumference of the inner layer. Further, the spokes, in an instance, may be double-sided spokes with multiple designs. For instance, the spokes may be thin and/or short in length and may be further pointed towards a center of the lighted hub-less rim.

Further, in some embodiments, different components associated with the lighted hub-less rim (such as the inner layer, the internal gear rim tooth ring, the spokes, the rear internal ring gear, and/or the front internal ring gear) may be designed and/or manufactured from a rigid, durable material which may be lightweight and/or may provide substantial structural strength, such as aluminum alloy. Further, the different components, in an instance, may be made up of materials such as (but not limited to) Iron, carbon steel, alloy steel, grey cast iron, nodular graphite cast iron, stainless steel, nonferrous metals, Titanium, and/or alloys, etc.

Further, the internal gear tooth ring of the lighted hub-less rim, in an instance, may be a ring structure with a number of cut teeth placed in between the inner layer and the outer layer of the lighted hub-less rim. Further, each cut teeth of the internal gear tooth ring, in an instance, may be configured to mesh with another toothed part in order to transmit torque. Further, the front internal ring gear, in an instance, may be a gear that may be mechanically coupled with the internal gear rim tooth ring of a front wheel of the vehicle. Further, the front internal ring gear, in an instance, may have a relatively smaller circumference (and/or diameter) than that of the internal gear rim tooth ring. Further, due to smaller circumference, the front internal ring gear may include a number of teeth significantly less than that of the internal gear rim tooth ring. Further, the rear internal ring gear, in an instance, may be a gear that may be mechanically coupled with the internal gear rim tooth ring of a rear wheel of the vehicle. Further, the rear internal ring gear, in an instance, may have a relatively smaller circumference (and/or diameter) than that of the internal gear rim tooth ring. Further, due to smaller circumference, the rear internal ring gear may include a number of teeth significantly less than that of the internal gear rim tooth ring. Further, the rear internal ring gear may receive a torque (through a chain) from pedals of the bicycle. Further, in order to move the bicycle, the rear internal ring gear may transfer torque (from the pedal) to the rear wheel of the bicycle by meshing with the teeth associated with the internal gear rim tooth ring.

Further, the inner layer of the lighted hub-less rim, in an instance, may be another ring structure with a diameter less than that of the outer layer and/or the internal gear rim tooth ring. Further, in one embodiment, the inner layer of the lighted hub-less rim may be configured to be coated with one or more colors that may light up in order to get easily distinguished by other drivers on the road. Further, the one or more colors associated with the inner layer of the lighted hub-less rim may include colors such as (but not limited to) lime green, pink, red, and/or blue, etc. Further, in another embodiment, the inner layer of the lighted hub-less rim may include one or more lights (such as, but not limited to, LEDs) that may be configured to illuminate the inner layer with the one or more colors. Further, the one or more lights, in an instance, may be configured to receive electrical power from a power source that may be present within the vehicle. Further, the power source, in an instance, may include (but not limited to) a battery. Further, the inner layer of the lighted hub-less rim, in an instance, may include a number of spokes. Further, the spokes, in an instance, may be spaced equally over the circumference of the inner layer. Further, the spokes, in an instance, may be double-sided spokes with multiple designs. For instance, the spokes may be thick and/or long and may be further pointed towards a center of the lighted hub-less rim.

Further, in some embodiments, different components associated with the lighted hub-less rim (such as the inner layer, the internal gear rim tooth ring, the spokes, the rear internal ring gear, and/or the front internal ring gear) may be designed and/or manufactured from a rigid, durable material which may be lightweight and/or may provide substantial structural strength, such as aluminum alloy. Further, the different components, in an instance, may be made up of materials such as (but not limited to) Iron, carbon steel, alloy steel, grey cast iron, nodular graphite cast iron, stainless steel, nonferrous metals, Titanium, and/or alloys, etc.

Components, component sizes, and materials listed above are preferable, but artisans will recognize that alternate components and materials could be selected without altering the scope of the invention.

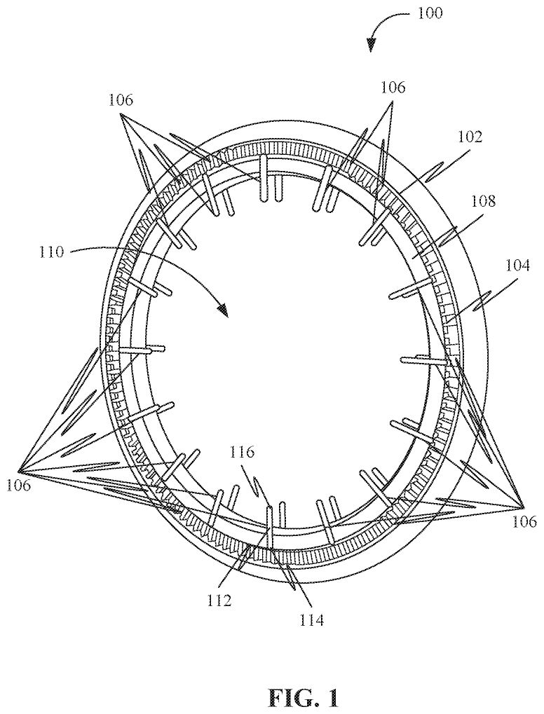

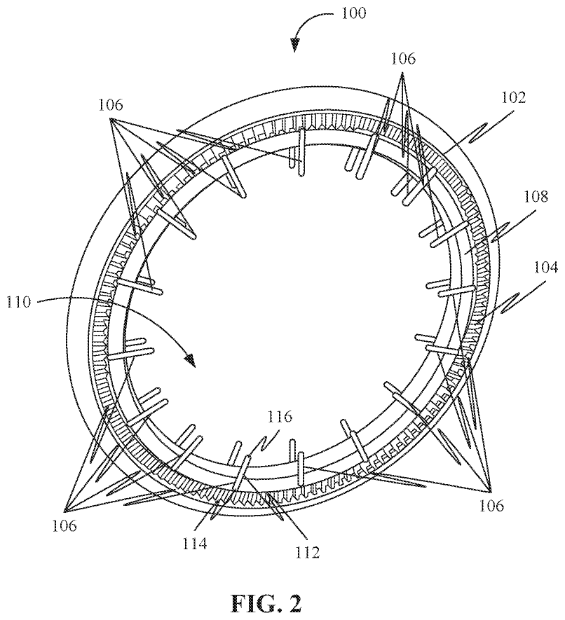

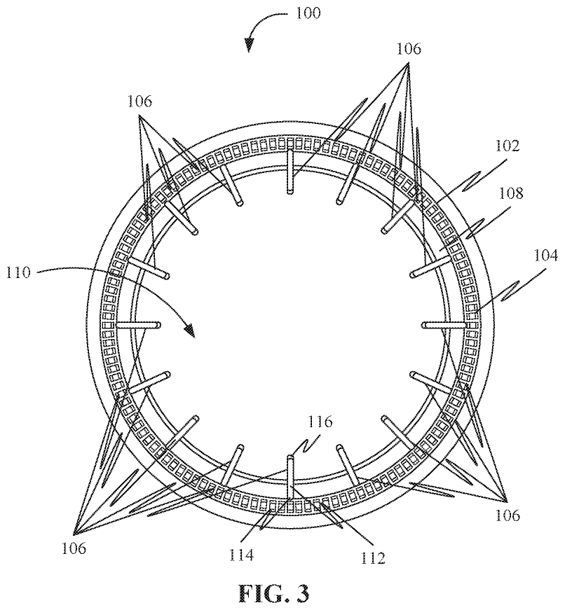

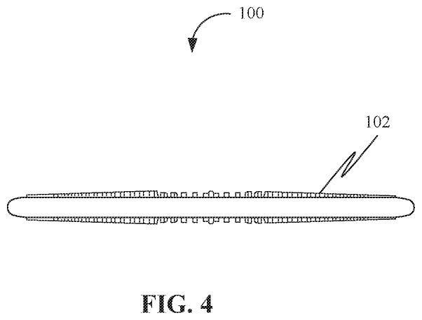

Referring now to figures, FIG. 1 is a front right-side perspective view of a hub-less rim 100 for a wheel of a vehicle, in accordance with some embodiments. FIG. 2 is a front left-side perspective view of the hub-less rim 100, in accordance with some embodiments. FIG. 3 is a side view of the hub-less rim 100, in accordance with some embodiments. FIG. 4 is a top view of the hub-less rim 100, in accordance with some embodiments. For example, the vehicle may include, but is not limited to, a bicycle, a motorcycle, a scooter, a car, a truck, and a bus. Further, the hub-less rim 100 may include an annular rim body 102, an internal gear rim tooth ring 104, a plurality of spokes 106 and a lighting device 108.

Further, the annular rim body 102 may be characterized by an inner rim circumference and an outer rim circumference forming a rim interior space 110. Further, the inner rim circumference may be associated with an inner boundary of the annular rim body 102. Further, the outer rim circumference may be associated with an outer periphery of the annular rim body 102. Further, the annular rim body 102 may include at least one side rim surface and a top rim surface. Further, each side rim surface in the at least one side rim surface may be defined by the inner rim circumference and the outer rim circumference.

In some embodiments, the top rim surface may be configured to grip to at least one surface for generating traction. Further, the traction facilitates the hub-less rim 100 to move on the at least one surface.

In some embodiments, a tire may be disposed on the annular rim body 102. Further, the tire may be attached to the top rim surface. Further, the tire may be configured to grip to at least one surface for generating traction. Further, the traction facilitates the hub-less rim 100 to move on the at least one surface.

Further, the internal gear rim tooth ring 104 may be disposed on the annular rim body 102. Further, the internal gear rim tooth ring 104 may be associated with a rim tooth ring circumference. Further, the internal gear rim tooth ring 104 may include a number of cut teeth corresponding to the rim tooth ring circumference. Further, the number of cut teeth may be disposed on a side rim surface of the at least one side rim surface proximal to the outer rim circumference. Further, a first set of parameters may be associated with the internal gear rim tooth ring 104. For example, the first set of parameters may include one or more of a gear size, a gear pitch, a pressure angle, a number of teeth, a module size, a circular pitch, a diameter pitch, a tooth depth, a tooth thickness, a center distance, and a backlash.

Further, the hub-less rim 100 may include a plurality of spokes 106 disposed on the annular rim body 102. Further, each spoke of the plurality of spokes 106 may include a base spoke end and a tip spoke end. Further, the base spoke end may be attached to the at least one side rim surface proximal to the inner rim circumference and the tip spoke end extends radially in the rim interior space 110. For example, a spoke 112 of the plurality of spokes 106 includes a base spoke end 114 and a tip spoke end 116.

In some embodiments, the plurality of spokes 106 may be equally spaced along the inner rim circumference. In alternate embodiments, the plurality of spokes 106 may be unequally spaced along the inner rim circumference.

Further, the hub-less rim 100 may include a lighting device 108 disposed on the annular rim body 102. Further, the lighting device 108 may be attached to the at least one side rim surface proximal to the inner rim circumference. Further, the lighting device 108 may be configured for emitting light of at least one color.

In some embodiments, the lighting device 108 may be configured for identifying the vehicle. Further, the light of each color of the at least one color corresponds to an identity of the vehicle. For example, the at least one color may help other drivers on the road to easily distinguish the vehicle with the lighting device 108.

In some embodiments, the lighting device 108 may include a neon light tube. Further, the neon light tube may be configured for emitting the light of the at least one color. In some embodiments, the lighting device 108 may include a Light Emitting Diode (LED). Further, the LED may be configured for emitting the light of the at least one color.

In further embodiments, the at least one side surface may be coated with a coating substance of at least one color. Further, the at least one color facilitates identifying of the vehicle. Further, each color of the at least one color corresponds to an identity of the vehicle.

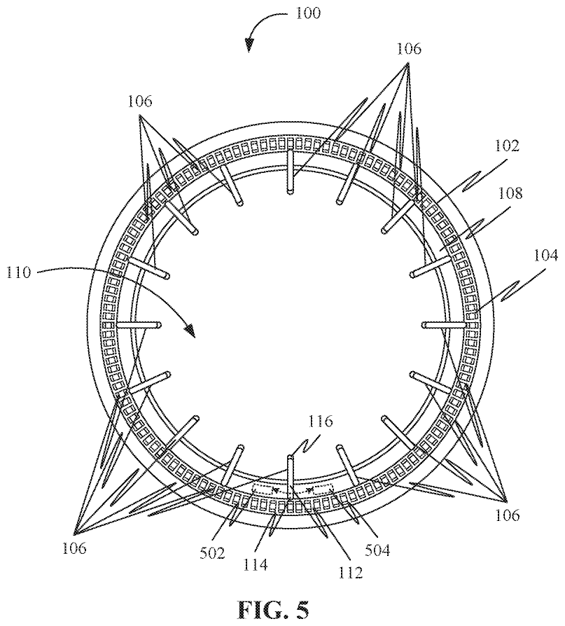

FIG. 5 is a side view of the hub-less rim 100, in accordance with some embodiments. Further, the hub-less rim 100 may include at least one sensor 502 disposed on the hub-less rim 100. Further, the at least one sensor 502 may be configured for generating at least one sensor data based on at least one state of the hub-less rim 100. For example, the at least one state may include an angular velocity of the hub-less rim 100, an orientation of the hub-less rim 100, etc.

Further, the hub-less rim 100 may include a processing device 504 communicatively coupled with the at least one sensor 502. Further, the processing device 504 may be configured for analyzing the at least one sensor data. Further, the processing device 504 may be configured for generating a state command based on the analyzing. Further, the lighting device 108 may be communicatively coupled with the processing device 504. Further, the lighting device 108 may be configured for emitting the light of the at least one color based on the state command.

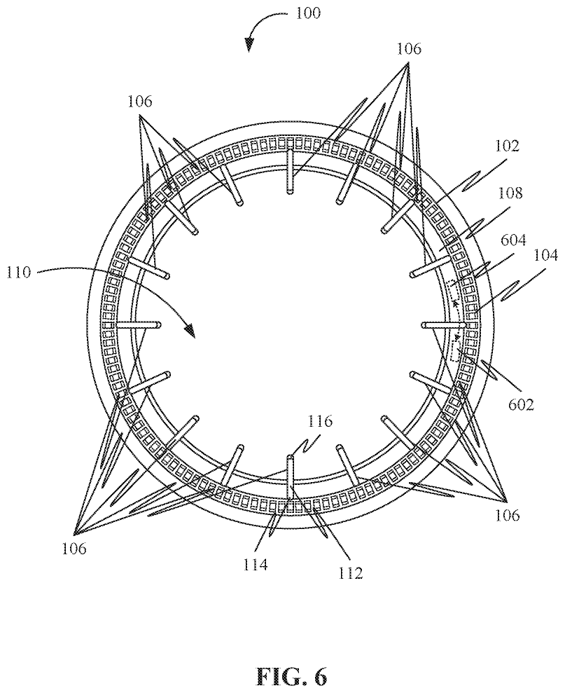

FIG. 6 is a side view of the hub-less rim 100, in accordance with some embodiments. Further, the hub-less rim 100 may include at least one input device 602 configured for generating at least one input data based on at least one action performed on the at least one input device 602 by a user.

Further, the hub-less rim 100 may include a processing device 604. The processing device 604 may be communicatively coupled with the at least input device. A user may use the at least input device to control the lighting device 108. Further, the processing device 604 may be configured for analyzing the at least one input data. Further, the processing device 604 may be configured for generating a display command based on the analyzing. Further, the lighting device 108 may be communicatively coupled with the processing device 604. Further, the lighting device 108 may be configured for emitting the light of the at least one color based on the display command.

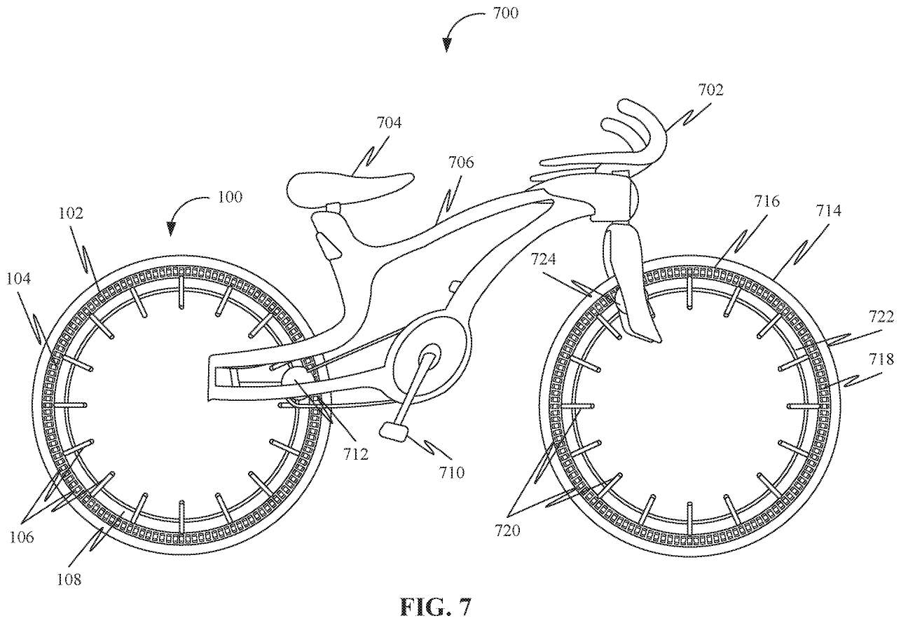

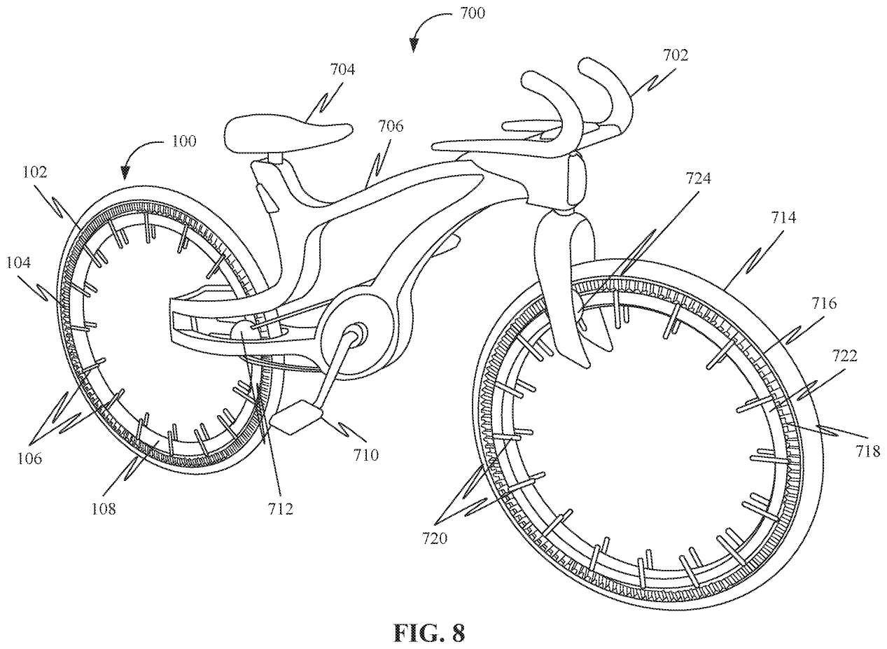

FIG. 7 is a side view of a vehicle 700 with the hub-less rim 100, in accordance with some embodiments. FIG. 8 is a front right-side view of the vehicle 700, in accordance with some embodiments. The vehicle 700 may include a handle 702, a seat 704, a frame 706, and at least one pedal 710.

Further, the vehicle 700 may include at least one internal gear disposed on the frame 706. Further, the at least one internal gear may include a first internal gear 712 and a second internal gear 724. Further, the internal gear rim tooth ring 104 may be configured to mechanically couple with the first internal gear 712. Further, a second set of parameters may be associated with the first internal gear 712. For example, the second set of parameters may include one or more of a gear size, a gear pitch, a pressure angle, a number of teeth, a module size, a circular pitch, a diameter pitch, a tooth depth, a tooth thickness, a center distance, and a backlash. Further, the first set of parameters and the second set of parameters may enable efficient mechanical coupling between the internal gear rim tooth ring 104 and the first internal gear 712.

Further, the first internal gear 712 may be associated with an internal gear circumference. Further, the internal gear circumference may be associated with an outer boundary of the first internal gear 712. Further, the first internal gear 712 may include a number of gear teeth corresponding to the internal gear circumference. Further, the internal gear circumference may be less than the rim tooth ring circumference. Further, the number of gear teeth may be less than the number of cut teeth.

In further embodiments, the first internal gear 712 may be operationally coupled with the drive mechanism of the vehicle 700. Further, the drive mechanism may be configured for generating a torque. Further, the first internal gear 712 may receive the torque from the drive mechanism. Further, the first internal gear 712 may transfer the torque to the internal gear rim tooth ring 104, thereby causing the rotation of the hub-less rim 100.

In further embodiments, the drive mechanism may include at least one pedal 710. Further, the at least one pedal 710 may be configured for transitioning through a plurality of pedal positions. Further, the transitioning of the at least one pedal 710 generates the torque. Further, the first internal gear 712 may receive the torque from the at least one pedal 710.

In some embodiments, the vehicle 700 may include another hub-less rim 714. Further, the hub-less rim 714 may include an annular rim body 716, an internal gear rim tooth ring 718, a plurality of spokes 720 and a lighting device 722. Further, the internal gear rim tooth ring 718 may be disposed on the annular rim body 716. Further, the internal gear rim tooth ring 718 may be associated with a rim tooth ring circumference. Further, the internal gear rim tooth ring 718 may include a number of cut teeth corresponding to the rim tooth ring circumference.

Further, the internal gear rim tooth ring 718 may be configured to mechanically couple with the second internal gear 724.

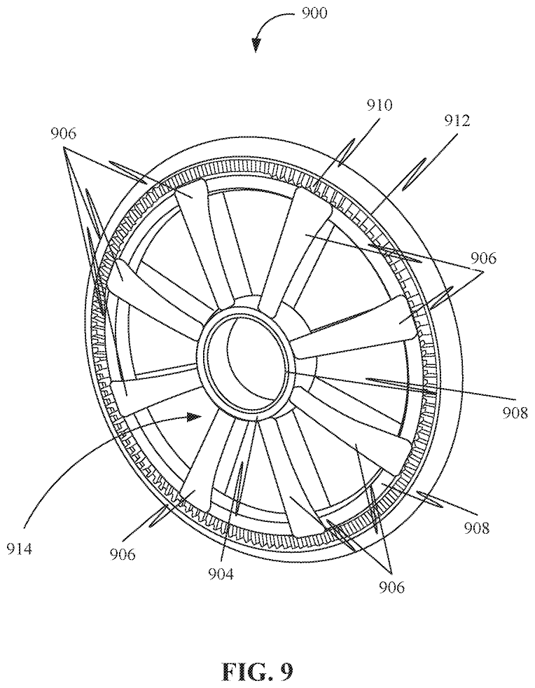

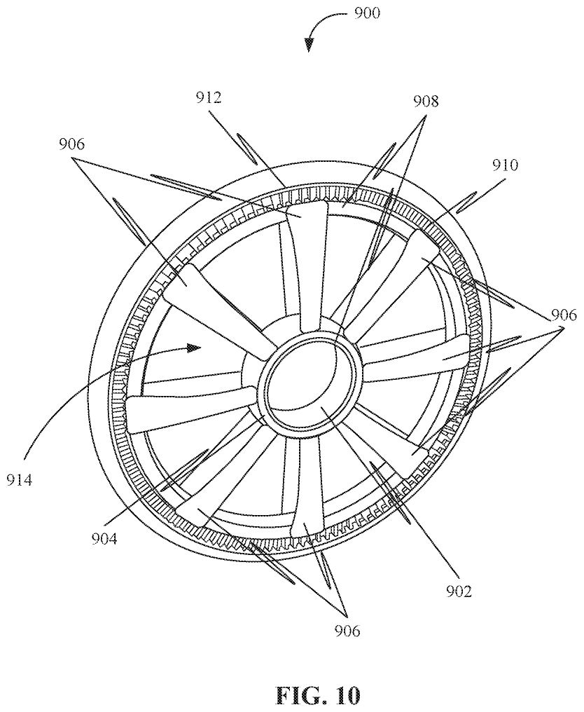

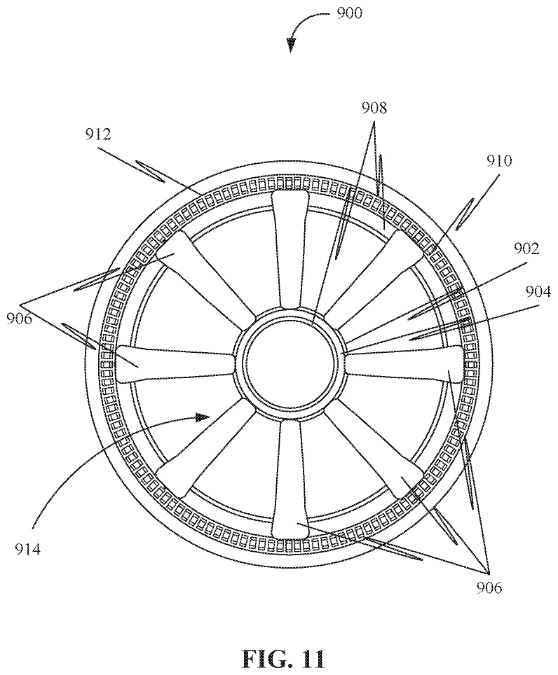

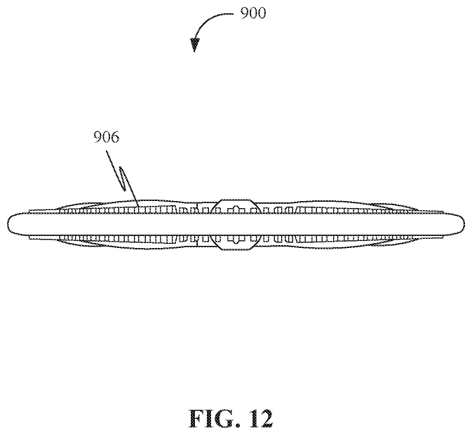

FIG. 9 is a front right-side perspective view of a hub-less rim 900 for a wheel of a vehicle, in accordance with some embodiments. FIG. 10 is a front left-side perspective view of the hub-less rim 900, in accordance with some embodiments. FIG. 11 is a side view of the hub-less rim 900, in accordance with some embodiments. FIG. 12 is a top view of the hub-less rim 900, in accordance with some embodiments.

Further, the hub-less rim 900 may include an annular rim body 912. Further, the annular rim body 912 may be characterized by an inner rim circumference and an outer rim circumference forming a rim interior space 914. Further, the annular rim body 912 may include at least one side rim surface and a top rim surface.

Further, the hub-less rim 900 may include an annular spoke body 902 disposed of concentrically in the rim interior space 914. Further, the annular spoke body 902 may be characterized by an outer spoke circumference and an inner spoke circumference. Further, the outer spoke circumference may be less than the inner rim circumference. Further, the annular spoke body 902 may include at least one spoke side surface 904 defined by the outer spoke circumference and the inner spoke circumference.

Further, the hub-less rim 900 may include a plurality of spokes 906. Further, each spoke of the plurality of spokes 906 may include a base spoke end and a tip spoke end. Further, the base spoke end may be attached to the at least one side rim surface proximal to the inner rim circumference. Further, the tip spoke end may be attached to the at least one spoke side surface 904 along the outer spoke circumference.

Further, a lighting device 908 may be disposed on the annular spoke body 902. Further, the lighting device 908 may be attached to the at least one spoke side surface 904. Further, the lighting device 908 may be disposed on the annular rim body 912. Further, the lighting device 908 may be attached to the at least one side rim surface.

Further, an internal gear rim tooth ring 910 may be disposed on the annular rim body 912.

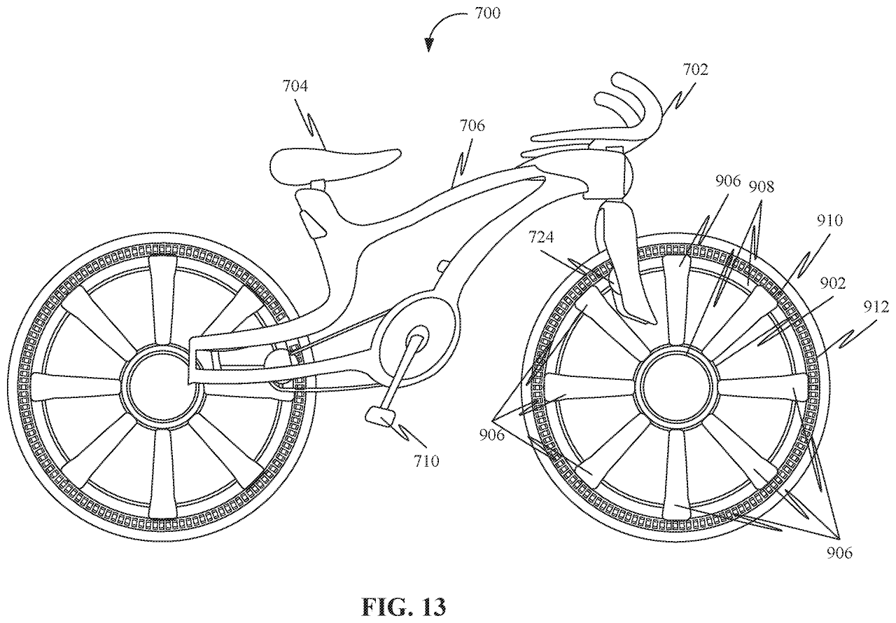

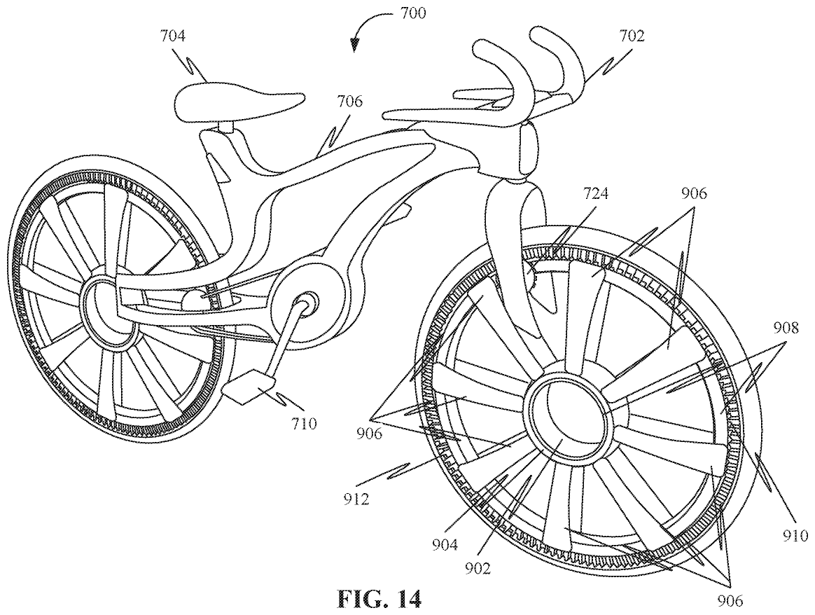

FIG. 13 is a side view of a vehicle 700 with the hub-less rim 900, in accordance with some embodiments. FIG. 14 is a front right-side perspective view of the vehicle 700, in accordance with some embodiments. The vehicle 700 may include a handle 702, a seat 704, a frame 706, and at least one pedal 710.

Further, an internal gear rim tooth ring 910 may be disposed on the annular rim body 902. Further, the internal gear rim tooth ring 910 may be configured to mechanically couple with the second internal gear 724.

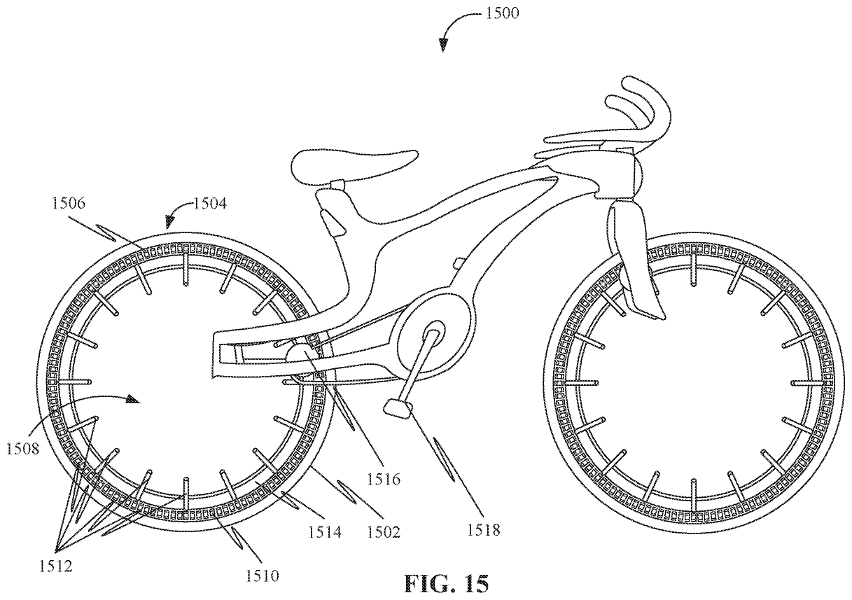

FIG. 15 is a side view of a vehicle 1500 with a hub-less rim 1502 for a wheel, in accordance with some embodiments. Further, the vehicle 1500 may include a vehicle body configured for accommodating at least one wheel 1504.

Further, the hub-less rim 1502 of the at least one wheel 1504 may include an annular rim body 1506 characterized by an inner rim circumference and an outer rim circumference forming a rim interior space 1508. Further, the annular rim body 1506 may include at least one side rim surface and a top rim surface. Further, each side rim surface in the at least one side rim surface is defined by the inner rim circumference and the outer rim circumference.

Further, the hub-less rim 1502 may include an internal gear rim tooth ring 1510 disposed on the annular rim body 1506. Further, the internal gear rim tooth ring 1510 may be associated with a rim tooth ring circumference. Further, the internal gear rim tooth ring 1510 may include a number of cut teeth corresponding to the rim tooth ring circumference. Further, the number of cut teeth may be disposed on a side rim surface of the at least one rim surface proximal to the outer rim circumference. Further, a third set of parameters may be associated with the internal gear rim tooth ring 1510. For example, the third set of parameters may include one or more of a gear size, a gear pitch, a pressure angle, a number of teeth, a module size, a circular pitch, a diameter pitch, a tooth depth, a tooth thickness, a center distance, and a backlash.

Further, the hub-less rim 1502 may include a plurality of spokes 1512 disposed on the annular rim body 1506. Further, each spoke of the plurality of spokes 1512 may include a base spoke end and a tip spoke end. Further, the base spoke end may be attached to the at least one side rim surface proximal to the inner rim circumference and the tip spoke end may extend radially in the rim interior space 1508.

Further, the hub-less rim 1502 may include a lighting device 1514 disposed on the annular rim body 1506. Further, the lighting device 1514 may be attached to the at least one side rim surface proximal to the inner rim circumference. Further, the lighting device 1514 may be configured for emitting light of at least one color.

Further, the vehicle 1500 may include at least one internal gear 1516 disposed on the vehicle body. Further, the at least one internal gear 1516 may be disposed on the vehicle body. Further, a fourth set of parameters may be associated with the at least one internal gear 1516. For example, the fourth set of parameters may include one or more of a gear size, a gear pitch, a pressure angle, a number of teeth, a module size, a circular pitch, a diameter pitch, a tooth depth, a tooth thickness, a center distance, and a backlash.

Further, the at least one internal gear 1516 may be mechanically coupled with the internal gear rim tooth ring 1510. Further, the third set of parameters and the fourth set of parameters may enable efficient mechanical coupling between the internal gear rim tooth ring 1510 and the at least one internal gear 1516.

Further, the at least one internal gear 1516 may be associated with an internal gear circumference. Further, the at least one internal gear 1516 may include a number of gear teeth corresponding to the internal gear circumference. Further, the internal gear circumference may be less than the rim tooth ring circumference and the number of gear teeth may be less than the number of the cut teeth.

Further, the vehicle 1500 may include a drive mechanism 1518 disposed on the vehicle body. Further, the drive mechanism 1518 may be operationally coupled with the at least one internal gear 1516. Further, the drive mechanism 1518 may be configured for generating a torque. Further, the at least one internal gear 1516 may receive the torque from the drive mechanism 1518. Further, the at least one internal gear 1516 may transfer the torque to the internal gear rim tooth ring 1510.

Further, the lighting device 1514 may be configured for identifying the vehicle 1500. Further, the light of each color of the at least one color corresponds to an identity of the vehicle 1500.

Further, at least one sensor (not shown) may be disposed on the hub-less rim 1502. Further, the at least one sensor may be configured for generating at least one sensor data based on at least one state of the hub-less rim 1502. Further, the hub-less rim 1502 may include a processing device (not shown) communicatively coupled with the at least one sensor. Further, the processing device may be configured for analyzing the at least one sensor data. Further, the processing device may be configured for generating a state command based on the analyzing. Further, the lighting device is communicatively coupled with the processing device. Further, the lighting device is configured for emitting the light of the at least one color based on the state command.

Further, the hub-less rim 1502 may include at least one input device (not shown) configured for generating at least one input data based on at least one action performed on the at least one input device by a user. Further, the hub-less rim 1502 may include a processing device (not shown) communicatively coupled with the at least input device. Further, the processing device may be configured for analyzing the at least one input data. Further, the processing device may be generating a display command based on the analyzing Further, the lighting device is communicatively coupled with the processing device Further, the lighting device is configured for emitting the light of the at least one color based on the display command.

In some embodiments, each of the hub-less rim 100, the hub-less rim 714, the hub-less rim 900, and the hub-less rim 1502 may include a communication device, a processing device, a storing device, and one or more sensors. Further, the communication device may be configured for transmitting sensor data to at least one user device. Further, the at least one user device may be associated with at least one user. Further, the at least one user device may include a computing device, such as but not limited to, a smartphone, a desktop, a laptop, a tablet, and so on.

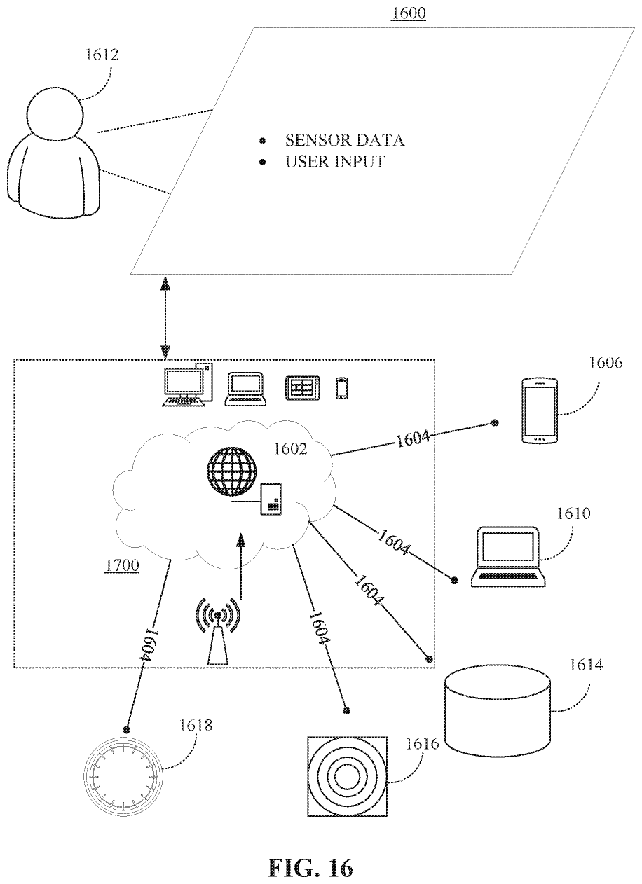

FIG. 16 is an illustration of an online platform 1600 consistent with various embodiments of the present disclosure. By way of non-limiting example, the online platform 1600 to facilitate operation of a hub-less rim (such as the hub-less rim 100, the hub-less rim 714, the hub-less rim 900, the hub-less rim 1502) may be hosted on a centralized server 1602, such as, for example, a cloud computing service. The centralized server 1602 may communicate with other network entities, such as, for example, a mobile device 1606 (such as a smartphone, a laptop, a tablet computer, etc.), other electronic devices 1610 (such as desktop computers, server computers, etc.), databases 1614, a hub-less rim 1618 (such as the hub-less rim 100, the hub-less rim 714, the hub-less rim 900, the hub-less rim 1502), and sensors 1616 (of the hub-less rim 100, the hub-less rim 714, the hub-less rim 900, the hub-less rim 1502) over a communication network 1604, such as but not limited to, the Internet. Further, users of the online platform 1600 may include relevant parties such as, but not limited to, end-users, administrators, and so on. Accordingly, in some instances, electronic devices operated by the one or more relevant parties may be in communication with the platform 1600.

A user 1612, such as the one or more relevant parties, may access online platform 1600 through a web-based software application or browser. The web-based software application may be embodied as, for example, but not be limited to, a website, a web application, a desktop application, and a mobile application compatible with a computing device 1700.

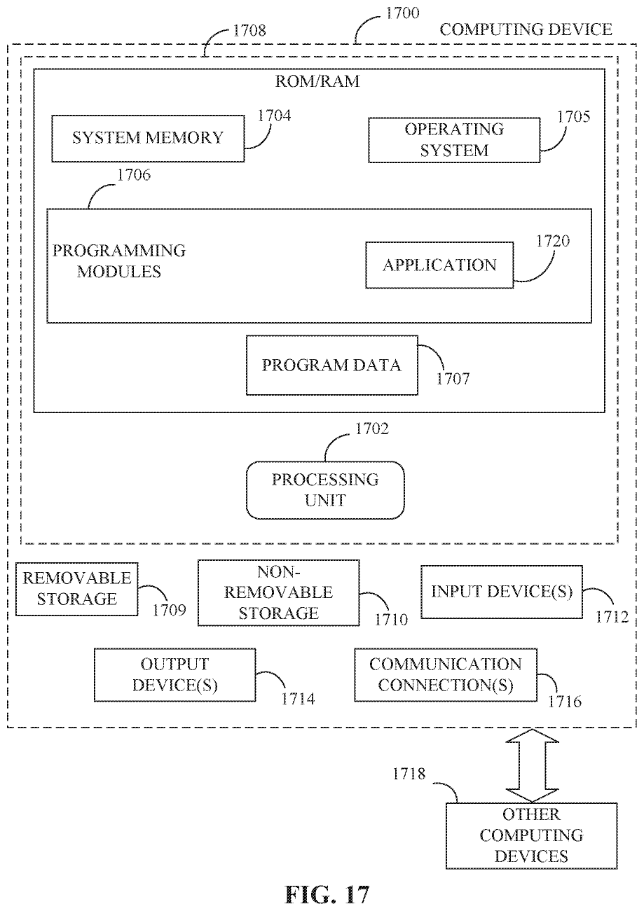

With reference to FIG. 17, a system consistent with an embodiment of the disclosure may include a computing device or cloud service, such as computing device 1700. In a basic configuration, computing device 1700 may include at least one processing unit 1702 and a system memory 1704. Depending on the configuration and type of computing device, system memory 1704 may comprise, but is not limited to, volatile (e.g. random-access memory (RAM)), non-volatile (e.g. read-only memory (ROM)), flash memory, or any combination. System memory 1704 may include operating system 1705, one or more programming modules 1706, and may include a program data 1707. Operating system 1705, for example, may be suitable for controlling computing device 1700′s operation. In one embodiment, programming modules 1706 may include image-processing module, machine learning module. Furthermore, embodiments of the disclosure may be practiced in conjunction with a graphics library, other operating systems, or any other application program and is not limited to any particular application or system. This basic configuration is illustrated in FIG. 17 by those components within a dashed line 1708.

Computing device 1700 may have additional features or functionality. For example, computing device 1700 may also include additional data storage devices (removable and/or non-removable) such as, for example, magnetic disks, optical disks, or tape. Such additional storage is illustrated in FIG. 17 by a removable storage 1709 and a non-removable storage 1710. Computer storage media may include volatile and non-volatile, removable and non-removable media implemented in any method or technology for storage of information, such as computer-readable instructions, data structures, program modules, or other data. System memory 1704, removable storage 1709, and non-removable storage 1710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1700. Any such computer storage media may be part of device 1700. Computing device 1700 may also have input device(s) 1712 such as a keyboard, a mouse, a pen, a sound input device, a touch input device, a location sensor, a camera, a biometric sensor, etc. Output device(s) 1714 such as a display, speakers, a printer, etc. may also be included. The aforementioned devices are examples and others may be used.

Computing device 1700 may also contain a communication connection 1716 that may allow device 1700 to communicate with other computing devices 1718, such as over a network in a distributed computing environment, for example, an intranet or the Internet. Communication connection 1716 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1704, including operating system 1705. While executing on processing unit 1702, programming modules 1706 (e.g., application 1720 such as a media player) may perform processes including, for example, one or more stages of methods, algorithms, systems, applications, servers, databases as described above. The aforementioned process is an example, and processing unit 1702 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The flowing is claimed:

1. A hub-less rim for a wheel of a vehicle, wherein the hub-less rim comprising:
an annular rim body characterized by an inner rim circumference and an outer rim circumference forming a rim interior space, wherein the annular rim body comprises at least one side rim surface and a top rim surface, wherein each side rim surface in the at least one side rim surface is defined by the inner rim circumference and the outer rim circumference;
an internal gear rim tooth ring disposed on the annular rim body, wherein the internal gear rim tooth ring is associated with a rim tooth ring circumference, wherein the internal gear rim tooth ring comprises a number of cut teeth corresponding to the rim tooth ring circumference, wherein the number of cut teeth is disposed on a side rim surface of the at least one side rim surface proximal to the outer rim circumference;
a plurality of spokes disposed on the annular rim body, wherein each spoke of the plurality of spokes comprises a base spoke end and a tip spoke end, wherein the base spoke end is attached to the at least one side rim surface proximal to the inner rim circumference and the tip spoke end extends radially in the rim interior space; and
a lighting device disposed on the annular rim body, wherein the lighting device is attached to the at least one side rim surface proximal to the inner rim circumference, wherein the lighting device is configured for emitting light of at least one color.

2. The hub-less rim of claim 1, wherein the lighting device is configured for identifying the vehicle, wherein the light of each color of the at least one color corresponds to an identity of the vehicle.

3. The hub-less rim of the claim 1, wherein the at least one side surface is coated with a coating substance of at least one color, wherein the at least one color facilitates identifying of the vehicle, wherein each color of the at least one color corresponds to an identity of the vehicle.

4. The hub-less rim of claim 1, wherein the lighting device comprises a neon light tube, wherein the neon light tube is configured for emitting the light of the at least one color.

5. The hub-less rim of claim 1, wherein the lighting device comprises an LED, wherein the LED is configured for emitting the light of the at least one color.

6. The hub-less rim of claim 1 further comprising:
at least one sensor disposed on the hub-less rim, wherein the at least one sensor is configured for generating at least one sensor data based on at least one state of the hub-less rim; and
a processing device communicatively coupled with the at least one sensor, wherein the processing device is configured for:
analyzing the at least one sensor data; and
generating a state command based on the analyzing, wherein the lighting device is communicatively coupled with the processing device, wherein the lighting device is configured for emitting the light of the at least one color based on the state command

7. The hub-less rim of claim 1 further comprising:
at least one input device configured for generating at least one input data based on at least one action performed on the at least one input device by a user; and
a processing device is communicatively coupled with the at least input device, wherein the processing device is configured for:
analyzing the at least one input data; and
generating a display command based on the analyzing, wherein the lighting device is communicatively coupled with the processing device, wherein the lighting device is configured for emitting the light of the at least one color based on the display command

8. The hub-less rim of claim 1 wherein the internal gear rim tooth ring is configured to mechanically couple with at least one internal gear of the vehicle, wherein the at least one internal gear is associated with an internal gear circumference, wherein the at least one internal gear comprises a number of gear teeth corresponding to the internal gear circumference, wherein the internal gear circumference is less than the rim tooth ring circumference, wherein the number of gear teeth is less than the number of cut teeth.

9. The hub-less rim of claim 8, wherein the at least one internal gear is operationally coupled with a drive mechanism of the vehicle, wherein the drive mechanism is configured for generating a torque, wherein the at least one internal gear receives the torque from the drive mechanism, wherein the at least one internal gear transfers the torque to the internal gear rim tooth ring.

10. The hub-less rim of the claim 9, wherein the drive mechanism comprises at least one pedal, wherein the at least one pedal is configured for transitioning through a plurality of pedal positions, wherein the transitioning of the pedal generates the torque, wherein the at least one internal gear receives the torque from the at least one pedal.

11. The hub-less rim of claim 1, wherein the plurality of spokes are equally spaced along the inner rim circumference.

12. The hub-less rim of claim 1, wherein the plurality of spokes are unequally spaced along the inner rim circumference.

13. The hub-less rim of claim 1, wherein the top rim surface is configured to grip to at least one surface for generating traction, wherein the traction facilitates the hub-less rim to move on the at least one surface.

14. The hub-less rim of claim 1 further comprising a tire disposed on the annular rim body, wherein the tire is attached to the top rim surface, wherein the tire is configured to grip to at least one surface for generating traction, wherein the traction facilitates the hub-less rim to move on the at least one surface.

15. The hub-less rim of claim 1 further comprises an annular spoke body disposed concentrically in the rim interior space, wherein the annular spoke body is characterized by an outer spoke circumference and an inner spoke circumference, wherein the outer spoke circumference is less than the inner rim circumference, wherein the annular spoke body comprises at least one spoke side surface defined by the outer spoke circumference and the inner spoke circumference, wherein the tip spoke end is attached to the at least one spoke side surface along the outer spoke circumference.

16. The hub-less rim of claim 15, wherein the lighting device is disposed on the annular spoke body, wherein the lighting device is attached to the at least one spoke side surface.

17. A vehicle with a hub-less rim for a wheel, wherein the vehicle comprising:
a vehicle body configured for accommodating at least one wheel;
a hub-less rim of the at least one wheel comprising:
an annular rim body characterized by an inner rim circumference and an outer rim circumference forming a rim interior space, wherein the annular rim body comprises at least one side rim surface and a top rim surface, wherein each side rim surface in the at least one side rim surface is defined by the inner rim circumference and the outer rim circumference;
an internal gear rim tooth ring disposed on the annular rim body, wherein the internal gear rim tooth ring is associated with a rim tooth ring circumference, wherein the internal gear rim tooth ring comprises a number of cut teeth corresponding to the rim tooth ring circumference, wherein the number of cut teeth is disposed on a side rim surface of the at least one rim surface proximal to the outer rim circumference;
a plurality of spokes disposed on the annular rim body, wherein each spoke of the plurality of spokes comprises a base spoke end and a tip spoke end, wherein the base spoke end is attached to the at least one side rim surface proximal to the inner rim circumference and the tip spoke end extends radially in the rim interior space; and
a lighting device disposed on the annular rim body, wherein the lighting device is attached to the at least one side rim surface proximal to the inner rim circumference, wherein the lighting device is configured for emitting light of at least one color;
at least one internal gear disposed on the vehicle body, wherein the at least one internal gear mechanically coupled with the internal gear rim tooth ring, wherein the at least one internal gear is associated with an internal gear circumference, wherein the at least one internal gear comprises a number of gear teeth corresponding to the internal gear circumference, wherein the internal gear circumference is less than the rim tooth ring circumference and the number of gear teeth is less than the number of the cut teeth; and
a drive mechanism disposed on the vehicle body, wherein the drive mechanism is operationally coupled with the at least one internal gear, wherein the drive mechanism is configured for generating a torque, wherein the at least one internal gear receives the torque from the drive mechanism, wherein the at least one internal gear transfers the torque to the internal gear rim tooth ring.

18. The vehicle of claim 17, wherein the lighting device is configured for identifying the vehicle, wherein the light of each color of the at least one color corresponds to an identity of the vehicle.

19. The vehicle of claim 17 further comprising:
at least one sensor disposed on the hub-less rim, wherein the at least one sensor is configured for generating at least one sensor data based on at least one state of the hub-less rim; and
a processing device communicatively coupled with the at least one sensor, wherein the processing device is configured for:
analyzing the at least one sensor data; and
generating a state command based on the analyzing, wherein the lighting device is communicatively coupled with the processing device, wherein the lighting device is configured for emitting the light of the at least one color based on the state command.

20. The vehicle of claim 17 further comprising:
at least one input device configured for generating at least one input data based on at least one action performed on the at least one input device by a user; and
a processing device is communicatively coupled with the at least input device, wherein the processing device is configured for:
analyzing the at least one input data; and
generating a display command based on the analyzing, wherein the lighting device is communicatively coupled with the processing device, wherein the lighting device is configured for emitting the light of the at least one color based on the display command.
